(19) United States
(12) Patent Application Publication
(10) Pub. No.: US 2024/0287324 A1
(43) Pub. Date: Aug. 29, 2024

(54) AQUEOUS FORMULATION COMPRISING AT LEAST ONE AQUEOUS HYDROPHOBIZING AGENT FOR PRODUCTION OF AQUEOUS COATING COMPOSITIONS HAVING IMPROVED EARLY RAIN RESISTANCE

(71) Applicant: Evonik Operations GmbH, Essen (DE)

(72) Inventors: Berend-Jan DE GANS, Muelheim an der Ruhr (DE); Oliver Peters, Muelheim an der Ruhr (DE); Giuseppe Giuffre, Oberhausen (DE); Laura Hübner, Essen (DE); Philippe Favresse, Ratingen (DE); Andrea Sowa, Essen (DE); Jonas Niedballa, Essen (DE); Jasmin Brokamp, Meerbusch (DE)

(73) Assignee: Evonik Operations GmbH, Essen (DE)

(21) Appl. No.: 18/587,215

(22) Filed: Feb. 26, 2024

(30) Foreign Application Priority Data
Feb. 27, 2023 (EP) 23158689.2

(51) Int. Cl. C09D 5/16; C09D 5/02; C09D 7/45; C09D 7/65

(52) U.S. Cl. CPC C09D 5/1687; C09D 5/022; C09D 5/027; C09D 5/1637; C09D 7/45; C09D 7/65

(57) ABSTRACT

An aqueous formulation that has at least one aqueous hydrophobizing agent and at least one water-soluble cationic polymer can be used to produce aqueous coating compositions that have improved early rain resistance. The water-soluble cationic polymer can have quaternary ammonium groups and amino groups. The hydrophobizing agent is an aqueous silicone resin emulsion, a silicone oil emulsion, an emulsion or microemulsion of an amino-functional silicone oil, a silane emulsion, or mixtures thereof.

### CROSS-REFERENCE TO RELATED APPLICATIONS

This application claims priority to European Application No. 23158689.2 filed on Feb. 27, 2023, the content of which is hereby incorporated by reference in its entirety.

### BACKGROUND OF THE INVENTION

### Field of the Invention

The present invention provides an aqueous formulation comprising at least one aqueous hydrophobizing agent for production of aqueous coating compositions having improved early rain resistance

### Description of Related Art

The drying rate of aqueous coating compositions depends on temperature and humidity. In the case of low humidity, the drying rate is often rapid, in some cases even more rapid than for solvent-based coating compositions. At high humidity and low temperatures, however, for example in the morning and evening, and before, during and after rainfall, the drying rate is distinctly slowed, since the evaporation of the water is retarded. Such coatings are then rain-resistant only after very long drying times. A particular early rain resistance or rainproofness of aqueous coating compositions before they have dried completely is desirable especially for exterior applications, for example paints for buildings, bridges, ships and road markings, and for exterior renders.

There are various principles of practical relevance for the achievement of such an early rain resistance or rainproofness.

In one variant of what is called the flocculation principle, the coating composition contains an anionically stabilized binder, a polyamine and ammonia as volatile base that evaporates after the application of the coating composition, which results in flocculation of the binder during drying (U.S. Pat. No. 5,527,853, EP 0 594 321, EP 0 728 822, EP 0 409 459). In another variant, the coating composition likewise contains an ionically stabilized binder. The flocculation thereof is effected in that an acid solution or a salt solution is sprayed simultaneously with the coating composition (WO 94/29 391, EP 0 200 249, U.S. Pat. Nos. 4,571,415, 5,403,393). A change in viscosity at the surface of the coating compositions can be achieved either in that a thickener is applied to the fresh coating, which results in an increase in viscosity, as disclosed, for example, in EP 0 721 003, or a base containing a thickener is applied to the fresh coating, but the thickener is not activated by virtue of establishment of a low pH.

EP 0 804 514 describes fast-drying aqueous coating compositions comprising an aqueous, anionically stabilized emulsion and a polyimine. The addition of a polyimine to a coating composition based on an aqueous, anionically stabilized emulsion has the disadvantage that the mixture, as soon as it has dried, has a tendency to yellow. This is the case particularly when emulsions based on vinyl acetate copolymers are used. For decorative exterior applications, this yellowing of the coating entails unwanted changes in shade.

Moreover, the charge of a polyimine, and hence flocculation, is dependent on pH. In the case of higher pH values, there is a shift in the charge equilibrium of the polyimine increasingly from the cationic to the neutral range, which leads to a loss of efficacy. However, modern coating compositions are often set to a relatively high pH in order to be able to reduce the propagation of microorganisms with simultaneously low use of biocides.

Also known is EP 1 250 388, in which a fast-drying aqueous coating composition containing at least one aqueous binder is described, which additionally contains at least one water-soluble quaternary poly(allylamine) and a nonionic surfactant. A disadvantage here, however, is the increase in viscosity during storage.

### SUMMARY OF THE INVENTION

It is therefore desirable to provide an aqueous formulation for production of a coating composition having early water resistance, without the disadvantages known from the prior art.

In order to solve this problem, an aqueous formulation comprising at least one hydrophobizing agent and at least one water-soluble cationic polymer is proposed.

Entirely unexpectedly, it has been found that the combination of hydrophobizing agents and water-soluble cationic polymers achieves an improvement in early rain resistance. The coatings produced with the aqueous formulation according to the invention had improved early rain resistance over conventional coatings. Advantageously, the aqueous coating composition according to the invention additionally showed a smaller increase in viscosity during storage.

The person skilled in the art is aware that the addition of a hydrophobizing agent can increase the hydrophobicity of a coating. In this way, it is possible to protect coatings and hence the substrates as well from the penetration of water. A hydrophobic coating or surface can be characterized by means of determination of the contact angle of a water droplet, which should be between 90° and 180° (Wässrige Siliconharz-Beschichtungssysteme für Fassaden: Grundlagen, Formulierungen, Anwendung in der Praxis, Problemlösungen [Aqueous Silicone Resin Coating Systems for Facades: Basics, Formulations, Practical Use, Solutions to Problems]/Wolfgang Schultze, 2nd edition, expert-verlag 2002, p. 18). For example, the contact angle can be determined with the aid of an optical contact angle measuring device in combination with a contour analysis system according to DIN 55660.

Typically, the hydrophobizing agent is introduced into the finished dispersion of the millbase in the form of an aqueous emulsion that has been produced using emulsifiers, and the binder is then additionally stirred into the finished dispersion. Such paints and renders, after application, still have relatively high water absorption capacity at first over a certain period of time (“washout period”), and so initial resistance to water is limited.

Most hydrophobizing agents are based on organosilicon compounds, which are used individually or in combination. Examples include alkoxysilanes, silicone oils, silicone resins and siliconates (see also: Wässrige Siliconharz-Beschichtungssysteme für Fassaden: Grundlagen, Formulierungen, Anwendung in der Praxis, Problemlösungen/Wolfgang Schultze, 2nd edition, expert-verlag 2002, p. 69-74).

### BRIEF DESCRIPTION OF THE DRAWINGS

FIG. 1 is an example of a photograph of the surface of the facade paints.

FIG. 2 is a second example of a photograph of the surface of the façade paints.

FIG. 3 is a third example of a photograph of the surface of the façade paints.

FIG. 4 is a fourth example of a photograph of the surface of the façade paints.

FIG. 5 is a fifth example of a photograph of the surface of the façade paints.

### DETAILED DESCRIPTION OF THE INVENTION

The alkoxysilanes are preferably compounds of formula (I)

R¹ₐSi(OR²)_{b} Formula (I)

in which a is not less than 0 to not more than 2, b is not less than 2 to not more than 4, and the sum total of a+b is 4, R¹ is a saturated or unsaturated alkyl group consisting of 1 to 8 carbon atoms, or an organic moiety consisting of 1 to 8 carbon atoms and 1 to 2 nitrogen or oxygen atoms, or an aromatic moiety having 6 to 20 carbon atoms and
R²=an alkyl or acyl group consisting of 1 to 8 carbon atoms.

Alkyl groups are preferably methyl, ethyl, propyl, isopropyl, n-butyl, s-butyl and t-butyl groups. The aromatic moiety is preferably a phenyl moiety. Preferred substituents R¹ are methyl or phenyl radicals, or mixtures of methyl and phenyl radicals. Preferred alkyl groups for the R² radical are methyl, ethyl, propyl, isopropyl, n-butyl, s-butyl or t-butyl groups. The alkoxysilane is preferably octyltriethoxysilane.

The silicone oils are preferably compounds of formula (II)

R³O(Si(R⁴)₂O)ₙR³ Formula (II)

R³ is independently a hydrogen atom or a trimethylsilyl or alkyl group, for example a methyl or ethyl group. R⁴ is independently an identical or different linear or branched, saturated or else mono- or polyunsaturated alkyl group consisting of 1 to 20 carbon atoms, or an organic moiety consisting of 1 to 8 carbon atoms and 1 to 2 nitrogen or oxygen atoms, or an organosilicon moiety consisting of one silicon atom, 1 to 15 carbon atoms and 1 to 4 oxygen atoms, or an aromatic moiety having 6 to 20 carbon atoms. R⁴ is preferably a methyl group, a 3-aminopropyl group, an N-2-(aminoethyl)-3-aminopropyl group, a 2-(trimethoxysilyl)ethyl group, a 2-(triethoxysilyl)ethyl group, or a phenyl group. The degree of polymerization n is between 1 and 10 000, preferably between 3 and 1000, and most preferably between 5 and 300.

The silicone resins are preferably polymeric compounds of formula (III)

R⁵_{c}Si(OR⁶)_{d}O_{(4-c-d)/2} Formula (III)
in which c is not less than 0 to not more than 2 and d is not less than 0 to not more than 4, and the sum total of c+d is less than 4. The R⁵ are independently identical or different linear or branched, saturated or else mono- or polyunsaturated or aromatic hydrocarbyl radicals, or an organic moiety consisting of 1 to 8 carbon atoms and 1 to 2 nitrogen or oxygen atoms. R⁶ is a hydrogen atom or an alkyl group consisting of 1 to 8 carbon atoms. R⁵ is preferably a methyl, propyl, phenyl, 3-aminopropyl or octyl group. R⁶ is preferably a hydrogen atom or a methyl or ethyl group.

Formula (III) is the smallest unit of the averaged structural formula of the silicone resin.

The hydrophobizing agent is preferably an aqueous silicone resin emulsion, a silicone oil emulsion, an emulsion or microemulsion of an amino-functional silicone oil, a silane emulsion, or mixtures thereof.

The hydrophobizing agent may preferably also be an aqueous emulsion based on two or more organosilicon compounds.

In general, any commercially available hydrophobizing agents are useful, provided that they can be used in aqueous coating compositions. Commercial hydrophobizing agents that should be mentioned here include: Tego Phobe® 1401, 1409, 1650, 1659, 6510 and 6600 from Evonik, Silres® BS45, BS54, BS60, BS6042, BS1001 and BS1306 from Wacker, Dowsil® IE 2404, IE 6683, IE 6694 and Z-70 Emulsion from Dow, Variphob® SR 550, SR 580, HP 105, HP 120 from CHT, Bluesil BP 9710, BP 9878, BP 9800, BP 9821, BP 9900, BP 9705, PB 9920 from Elkem Silicones and Silsan® CC55, HSB, DSH, WS 1800, 1300 and 1350 from Graf Chemicals.

The water-soluble cationic polymer preferably has quaternary ammonium groups.

Suitable water-soluble cationic polymers are preferably those compounds selected from poly[(dimethylimino)-2-butene-1,4-diyl] chloride (Polyquaternium-1), poly(diallyldimethylammonium chloride) (Polyquaternium-6), copolymer of acrylamide with quaternized dimethylammoniumethyl methacrylate, poly{bis(2-chloroethyl) ether-alt-1,3-bis[3(dimethylamino) propyl]urea} (Polyquaternium-2), hydroxyethylcellulosedimethyldiallylammonium chloride copolymer (Polyquaternium-4), poly(acrylamide-methacryloyloxyethyltrimethylammonium methylsulfate) (Polyquaternium-5), poly(diallyldimethylammonium chloride-co-acrylamide) (Polyquaternium-7), quaternized hydroxyethyl cellulose (Polyquaternium-10), copolymer of methyl- and stearyldimethylaminoethyl methacrylate, quaternized with dimethyl sulfate (Polyquaternium-8), poly-N,N-(dimethylamino)ethyl methacrylate, quaternized with bromoethane (Polyquaternium-9), poly(vinylpyrrolidone-co-dimethylaminoethyl methacrylate, quaternized) (Polyquaternium-11), poly(ethyl methacrylate-co-abietyl methacrylate-co-diethylaminoethyl methacrylate) quaternized with dimethyl sulfate (Polyquaternium-12), poly(ethyl methacrylate-co-oleyl methacrylate-co-diethylaminoethyl methacrylate) quaternized with dimethyl sulfate (Polyquaternium-13), poly(2-methacryloyloxyethyltrimethylammonium methylsulfate) (Polyquaternium-14), poly(acrylamide-co-trimethylammonioethyl methacrylate chloride) (Polyquaternium-15), 3-methyl-1-vinylimidazolium chloride-N-vinylpyrrolidone copolymer (Polyquaternium-16), poly[oxy-1,2-ethanediyl(dimethyliminio)-1,3-propanediylimino(1,6-dioxo-1,6-hexanediyl)imino-1,3-propanediyl(dimethyliminio)-1,2-ethanediyl dichloride] (Polyquaternium-17), poly[oxy-1,2-ethanediyl(dimethyliminio)-1,3-propanediylimino(1,9-dioxo-1,9-nonanediyl)imino-1,3-propanediyl(dimethyliminio)-1,2-ethanediyl chloride (Polyquaternium-18), poly(diallyldimethylammonium chloride-acrylic acid) (Polyquaternium-22), cellulose, ether with α-[3-(dodecyldimethylammonio)-2-hydroxypropyl]-w-hydroxypoly(oxy-1,2-ethanediyl), chloride (Polyquaternium-24), N-vinyl-2-pyrrolidone-3-methacrylamidopropyltrimethylammonium chloride copolymer (Polyquaternium-28), 2-propenoic acid, 2-methyl-, methyl ester, polymer with N-(carboxymethyl)-N,N-dimethyl-2-[(2-methyl-1-oxo-2-propenyl)oxy]ethanaminium zwitterion (Polyquaternium-30), 2-acryloxyethyltrimethylammonium chloride-acrylamide copolymer (Polyquaternium-33), 2-propenoic acid, 2-methyl-, methyl ester, polymer of 2-(dimethylamino)ethyl 2-methyl-2-propenoate, compound with dimethyl sulfate (Polyquaternium-36), poly(2-methacryloxyethyltrimethylammonium chloride) (Polyquaternium-37), acrylic acid-acrylamide-dimethyldiallylammonium chloride copolymer (Polyquaternium-39), poly[oxyethylene(dimethylamino)ethylene(dimethylamino)ethylene dichloride] (Polyquaternium-42), 3-methyl-1-vinylimidazolium methylsulfate-N-vinylpyrrolidone copolymer (Polyquaternium-44), 3-methyl-N-vinylimidazolium methylsulfate-N-vinylcaprolactam-N-vinyl-2-pyrrolidone copolymer (Polyquaternium-46), acrylic acid-methacrylamidopropyl trimethylammonium chloride-methyl acrylate copolymer (Polyquaternium-47), N-methacryloyloxyethyl-N,N-dimethylammonium α-N-methylcarboxybetaine polymer (Polyquaternium-50), butyl methacrylate-2-methacryloyloxyethylphosphorylcholine copolymer (Polyquaternium-51), N,N-dimethylacrylamide-dimethylaminoethyl methacrylate diethylsulfate-polyethyleneglycol dimethacrylate copolymer (Polyquaternium-52), poly(acrylamide-methacrylamidopropyltrimethylammonium chloride-acrylic acid) (Polyquaternium-53), 1-dodecanaminium, N,N-dimethyl-N-[3-[(2-methyl-1-oxo-2-propenyl)amino]propyl]-, chloride, polymer with N-[3-(dimethylamino)propyl]-2-methyl-2-propenamide and 1-ethenyl-2-pyrrolidinone (Polyquaternium-55), 2-(methacryloyloxy)ethyl-2-(trimethylammonium)ethyl phosphate-stearyl methacrylate copolymer (Polyquaternium-61), poly(acrylamide-acrylic acid-acryloyloxyethyltrimethylammonium chloride) (Polyquaternium-63), 2-hydroxy-3-methacryloxypropyltrimethylammonium chloride-2-methacryloxyethyl phosphorylcholine copolymer (Polyquaternium-64), cellulose, 2-[3-(dodecyldimethylammonio)-2-hydroxypropoxy]ethyl 3-(dodecyldimethylammonio)-2-hydroxypropyl 2-hydroxyethyl 2-[2-hydroxy-3-(trimethylammonio)propoxy]ethyl 2-hydroxy-3-(trimethylammonio)propyl ether, chloride (Polyquaternium-67), methacrylamide-N-vinylimidazole-N-vinylimidazole methosulfate-N-vinyl-2-pyrrolidone copolymer (Polyquaternium-68), 1-dodecanaminium, N,N-dimethyl-N-[3-[(2-methyl-1-oxo-2-propenyl)amino]propyl]-, chloride, polymer with N-[3-(dimethylamino)propyl]-2-methyl-2-propenamide, 1-ethenylhexahydro-2H-azepin-2-one and 1-ethenyl-2-pyrrolidinone (Polyquaternium-69), 1-propanaminium, N,N,N-trimethyl-3-[(1-oxo-2-propen-1-yl)amino]-, chloride (1:1), polymer with N, N-dimethyl-2-propenamide, 2-hydroxyethyl 2-methyl-2-propenoate and N, N, N-trimethyl-2-[(2-methyl-1-oxo-2-propen-1-yl)oxy]ethanaminium chloride (1:1) (Polyquaternium-84), 1H-imidazolium, 1-ethenyl-3-methyl-, chloride (1:1), polymer with 1-ethenyl-1H-imidazole, 1-ethenyl-2-pyrrolidinone and 2-methyl-2-propenoic acid (Polyquaternium-86), acrylic acid-ethyl acrylate-(3-methacrylamidopropyl)trimethylammonium chloride copolymer (Polyquaternium-98), ethanaminium, N,N,N-trimethyl-2-[(2-methyl-1-oxo-2-propen-1-yl)oxy]-, chloride (1:1), polymer with butyl 2-methyl-2-propenoate and 2-ethoxyethyl 2-methyl-2-propenoate (Polyquaternium-99), poly[(dimethyliminio)(2-hydroxy-1,3-propanediyl)(dimethyliminio)-1,6-hexanediyl dichloride] (Polyquaternium-100), 2-methacryloyloxyethyl phosphorylcholine-3-N,N-dimethylaminopropylacrylamide-stearyl methacrylate copolymer (Polyquaternium-107), 2-propene-1-aminium, N,N-dimethyl-N-2-propen-1-yl-, chloride (1:1), polymer with 2-hydroxy-1-methylethyl-2-propenoate and 2-propenoic acid (Polyquaternium-111), quaternized polysaccharides and derivatives, polysaccharide for example guar hydroxypropyltrimethylammonium chloride and hydroxypropylguar hydroxypropyltrimethylammonium chloride, chitosan hydroxypropyltrimethylammonium chloride, starch 3-(dodecyldimethylammonio)-2-hydroxypropyl 2-hydroxy-3-(trimethylammonio)propyl ether chloride (Polyquaternium-75) and hydroxypropyltrimethylammonium chloride starch.

Particular preference is given to poly(diallyldimethylammonium chloride) and quaternized hydroxyethyl cellulose. Most preferred is poly(diallyldimethylammonium chloride).

The water-soluble cationic polymer preferably has amino groups. Particular preference is given to polyethyleneimine.

The weight-average molecular weight of the water-soluble cationic polymer is preferably in the range of 10 000 g/mol to 2 000 000 g/mol, more preferably in the range of 20 000 g/mol to 1 000 000 g/mol and most preferably in the range of 30 000 g/mol to 500 000 g/mol.

The aqueous formulation preferably includes 0.05% by weight-5.0% by weight, preferably 0.1% by weight-3.0% by weight, more preferably 0.2% by weight-2.0% by weight, of the cationic polymer based on the formulation.

A further invention is the use of the aqueous formulation according to the invention as additive for production of aqueous coating compositions with improved early rain resistance.

The invention also provides coating compositions comprising an aqueous formulation according to the invention.

The coating composition, as well as the aqueous formulation according to the invention, optionally also contains film-forming aids, pigments, fillers, thickeners, levelling agents, dispersants, wetting agents, preservatives, emulsifiers, protective colloids and/or defoamers.

The coating compositions according to the invention are preferably renders, paints, primers or wood paints for exterior applications. The coating compositions according to the invention are more preferably synthetic resin renders, facade paints, roadmarking paints or wood protection paints.

The present invention also provides a process for producing a coating composition having early water resistance, wherein
a) first an aqueous formulation is produced, consisting of at least one aqueous hydrophobizing agent and at least one aqueous cationic polymer solution, the weight-average molecular weight of which is in the range of 10 000 g/mol to 1 000 000 g/mol.
b) then at least one aqueous binder is added to the formulation obtained according to a) and
c) optionally, an emulsifier or a mixture of emulsifiers, film-forming aids, pigments, fillers, thickeners, levelling agents, protective colloids, dispersants, wetting agents, preservatives and/or defoamers is added.

It has now been found that, surprisingly, the coating produced by the process according to the invention had improved early rain resistance compared to conventional coatings.

The binder may of course also be a mixture of different binders.

The proportion by weight of binders (in solid form) in the coating composition is preferably between 1.0-50.0% by weight and more preferably between 3.0-25.0% by weight, based on the weight of dry material in the coating composition.

The aqueous binder is preferably added to the mixture as the last constituent if an emulsifier or a mixture of emulsifiers, film-forming aids, pigments, fillers, thickeners, levelling agents, protective colloids, dispersants, wetting agents, preservatives and/or defoamers is used.

The binders are preferably aqueous polymer dispersions based on homo- and/or copolymers.

Particularly preferred homo- and copolymers contain at least one olefinically unsaturated monomer as monomer unit.

Especially preferred are copolymers containing 70% to 99.7% by weight, based on the total amount of monomers, of free-radically polymerizable olefinically unsaturated compounds from the group of the acrylic and methacrylic esters of (C1 to C12) monoalcohols, preferably of (C1 to C8) monoalcohols, for example methanol, ethanol, isopropanol, isobutanol, n-butanol and 2-ethylhexyl alcohol, the vinylaromatic monomers, for example styrene, the vinyl esters of (C1 to C12)-alkanemonocarboxylic acids, for example vinyl acetate, vinyl propionate, vinyl n-butyrate, vinyl laurate, VeoVa® 9 and VeoVa® 10, the vinyl halides, for example vinyl chloride and vinylidene chloride, the α- and β-mono-olefinically unsaturated nitriles, for example acrylonitrile and methacrylonitrile, and the alkyl esters of mono-olefinically unsaturated dicarboxylic acids, for example di-n-butyl maleate and di-n-butyl fumarate. The copolymers preferably also contain 0.3% to 10% by weight, more preferably 0.5% to 5% by weight, based on the total amount of the monomers, of α- and β-mono-olefinically unsaturated mono- and dicarboxylic acids, for example acrylic acid, methacrylic acid, itaconic acid, maleic acid and fumaric acid, and the amides thereof optionally having substitution on the nitrogen atoms, for example acrylamide, methacrylamide, N-methylolacrylamide and N-butoxymethacrylamide.

In addition, it is possible for 0% to 20% by weight, preferably 0.5% to 5% by weight, based on the total amount of the monomers, of functional monomers to be present in the copolymers, for example hydroxyl group-containing monomers such as hydroxyalkyl acrylates and methacrylates, especially hydroxyethyl methacrylate and hydroxypropyl methacrylate, and/or acetylacetoxy group-containing monomers that improve wet adhesion, especially allyl acetoacetate, acetylacetoxyethyl methacrylate and acetylacetoxybutyl methacrylate, and/or crosslinking monomers such as monomers containing epoxy groups and silane groups, especially glycidyl acrylate, glycidyl methacrylate, vinyltrimethoxysilane and methacryloxypropyltrimethoxysilane, and/or nitrogen-containing monomers from the group of the polymerizable monomers having an amino, ureido or N-heterocyclic group, for example dimethylaminoethyl acrylate and methacrylate, N-(2-methacryloylethyl)ethyleneurea, and/or keto group-containing monomers, for example diacetoneacrylamide, diacetonemethacrylamide, acrolein and 2-butanone methacrylate.

In self-crosslinking dispersions, it is possible for keto group-containing polymers to be present up to 5% by weight, based on the total amount of the monomers, or of a di- or polyfunctional carboxylic acid hydrazide, for example adipic hydrazide.

The polymer dispersions used as binders are preferably anionically stabilized polymer dispersions, or polymer dispersions stabilized by mixtures of nonionic and anionic stabilizers or mixtures of nonionic emulsifiers, anionic emulsifiers and protective colloids.

Suitable nonionic emulsifiers are, for example, alkyl polyglycol ethers or alkoxylation products of polypropylene oxide. Useful anionic emulsifiers are primarily the alkali metal or ammonium salts of alkyl sulfonates, sulfates, phosphates or phosphonates, aryl sulfonates, sulfates, phosphates or phosphonates, or alkylaryl sulfonates, sulfates, phosphates or phosphonates.

Suitable protective colloids are natural products, for example, gum arabic, starch and alginates, modified natural products, for example cellulose derivatives, or synthetic polymers, for example polyvinylalcohol and polyvinylpyrrolidone, or mixtures thereof.

As well as emulsifiers and protective colloids, the polymer dispersions may optionally also contain additives, auxiliaries and/or non-copolymerizable crosslinkers.

Preference is given to using an aqueous formulation comprising 0.05% by weight-5.0% by weight, preferably 0.1% by weight-3.0% by weight, more preferably 0.2% by weight-2.0% by weight, of the cationic polymer based on the formulation for the process according to the invention.

The cationic polymer preferably has quaternary ammonium groups.

Suitable water-soluble cationic polymers are preferably those compounds selected from poly[(dimethylimino)-2-butene-1,4-diyl] chloride (Polyquaternium-1), poly(diallyldimethylammonium chloride) (Polyquaternium-6), copolymer of acrylamide with quaternized dimethylammoniumethyl methacrylate, poly{bis(2-chloroethyl) ether-alt-1,3-bis[3(dimethylamino) propyl]urea} (Polyquaternium-2), hydroxyethylcellulosedimethyldiallylammonium chloride copolymer (Polyquaternium-4), poly(acrylamide-methacryloyloxyethyltrimethylammonium methylsulfate) (Polyquaternium-5), poly(diallyldimethylammonium chloride-co-acrylamide) (Polyquaternium-7), quaternized hydroxyethyl cellulose (Polyquaternium-10), copolymer of methyl- and stearyldimethylaminoethyl methacrylate, quaternized with dimethyl sulfate (Polyquaternium-8), poly-N,N-(dimethylamino)ethyl methacrylate, quaternized with bromoethane (Polyquaternium-9), poly(vinylpyrrolidone-co-dimethylaminoethyl methacrylate, quaternized) (Polyquaternium-11), poly(ethyl methacrylate-co-abietyl methacrylate-co-diethylaminoethyl methacrylate) quaternized with dimethyl sulfate (Polyquaternium-12), poly(ethyl methacrylate-co-oleyl methacrylate-co-diethylaminoethyl methacrylate) quaternized with dimethyl sulfate (Polyquaternium-13), poly(2-methacryloyloxyethyltrimethylammonium methylsulfate) (Polyquaternium-14), poly(acrylamide-co-trimethylammonioethyl methacrylate chloride) (Polyquaternium-15), 3-methyl-1-vinylimidazolium chloride-N-vinylpyrrolidone copolymer poly[oxy-1,2-ethanediyl(dimethyliminio)-1,3-propanediylimino(1,6-dioxo-1,6-(Polyquaternium-16), hexanediyl)imino-1,3-propanediyl(dimethyliminio)-1,2-ethanediyl dichloride] (Polyquaternium-17), poly[oxy-1,2-ethanediyl(dimethyliminio)-1,3-propanediylimino(1,9-dioxo-1,9-nonanediyl)imino-1,3-propanediyl(dimethyliminio)-1,2-ethanediyl chloride (Polyquaternium-18), poly(diallyldimethylammonium chloride-acrylic acid) (Polyquaternium-22), cellulose, ether with a-[3-(dodecyldimethylammonio)-2-hydroxypropyl]-w-hydroxypoly(oxy-1,2-ethanediyl), chloride (Polyquaternium-24), N-vinyl-2-pyrrolidone-3-methacrylamidopropyltrimethylammonium chloride copolymer (Polyquaternium-28), 2-propenoic acid, 2-methyl-, methyl ester, polymer with N-(carboxymethyl)-N,N-dimethyl-2-[(2-methyl-1-oxo-2-propenyl) oxy]ethanaminium zwitterion (Polyquaternium-30), 2-acryloxyethyltrimethylammonium chloride-acrylamide copolymer (Polyquaternium-33), 2-propenoic acid, 2-methyl-, methyl ester, polymer of 2-(dimethylamino)ethyl 2-methyl-2-propenoate, compound with dimethyl sulfate (Polyquaternium-36), poly(2-methacryloxyethyltrimethylammonium chloride) (Polyquaternium-37), acrylic acid-acrylamide-dimethyldiallylammonium chloride copolymer (Polyquaternium-39), poly[oxyethylene(dimethylamino)ethylene(dimethylamino)ethylene dichloride] (Polyquaternium-42), 3-methyl-1-vinylimidazolium methylsulfate-N-vinylpyrrolidone copolymer (Polyquaternium-44), 3-methyl-N-vinylimidazolium methylsulfate-N-vinylcaprolactam-N-vinyl-2-pyrrolidone copolymer (Polyquaternium-46), acrylic acid-methacrylamidopropyl trimethylammonium chloride-methyl acrylate copolymer (Polyquaternium-47), N-methacryloyloxyethyl-N,N-dimethylammonium a-N-methylcarboxybetaine methacrylate-2-polymer (Polyquaternium-50), butyl methacryloyloxyethylphosphorylcholine copolymer (Polyquaternium-51), N,N-dimethylacrylamide-dimethylaminoethyl methacrylate diethylsulfate-polyethyleneglycol dimethacrylate copolymer (Polyquaternium-52), poly(acrylamide-methacrylamidopropyltrimethylammonium chloride-acrylic acid) (Polyquaternium-53), 1-dodecanaminium, N,N-dimethyl-N-[3-[(2-methyl-1-oxo-2-propenyl)amino]propyl]-, chloride, polymer with N-[3-(dimethylamino)propyl]-2-methyl-2-propenamide and 1-ethenyl-2-pyrrolidinone (Polyquaternium-55), 2-(methacryloyloxy)ethyl-2-(trimethylammonium)ethyl phosphate-stearyl methacrylate copolymer (Polyquaternium-61), poly(acrylamide-acrylic acid-acryloyloxyethyltrimethylammonium chloride) (Polyquaternium-63), 2-hydroxy-3-methacryloxypropyltrimethylammonium chloride-2-methacryloxyethyl phosphorylcholine copolymer (Polyquaternium-64), cellulose, 2-[3-(dodecyldimethylammonio)-2-hydroxypropoxy]ethyl 3-(dodecyldimethylammonio)-2-hydroxypropyl 2-hydroxyethyl 2-[2-hydroxy-3-(trimethylammonio)propoxy]ethyl 2-hydroxy-3-(trimethylammonio)propyl ether, chloride (Polyquaternium-67), methacrylamide-N-vinylimidazole-N-vinylimidazole methosulfate-N-vinyl-2-pyrrolidone copolymer (Polyquaternium-68), 1-dodecanaminium, N,N-dimethyl-N-[3-[(2-methyl-1-oxo-2-propenyl) amino]propyl]-, chloride, polymer with N-[3-(dimethylamino)propyl]-2-methyl-2-propenamide, 1-ethenylhexahydro-2H-azepin-2-one and 1-ethenyl-2-pyrrolidinone (Polyquaternium-69), 1-propanaminium, N,N,N-trimethyl-3-[(1-oxo-2-propen-1-yl)amino]-, chloride (1:1), polymer with N, N-dimethyl-2-propenamide, 2-hydroxyethyl 2-methyl-2-propenoate and N,N, N-trimethyl-2-[(2-methyl-1-oxo-2-propen-1-yl)oxy]ethanaminium chloride (1:1) (Polyquaternium-84), 1H-imidazolium, 1-ethenyl-3-methyl-, chloride (1:1), polymer with 1-ethenyl-1H-imidazole, 1-ethenyl-2-pyrrolidinone and 2-methyl-2-propenoic acid (Polyquaternium-86), acrylic acid-ethyl acrylate-(3-methacrylamidopropyl)trimethylammonium chloride copolymer (Polyquaternium-98), ethanaminium, N,N,N-trimethyl-2-[(2-methyl-1-oxo-2-propen-1-yl)oxy]-, chloride (1:1), polymer with butyl 2-methyl-2-propenoate and 2-ethoxyethyl 2-methyl-2-propenoate (Polyquaternium-99), poly[(dimethyliminio)(2-hydroxy-1,3-propanediyl)(dimethyliminio)-1,6-hexanediyl dichloride] (Polyquaternium-100), 2-methacryloyloxyethyl phosphorylcholine-3-N,N-dimethylaminopropylacrylamide-stearyl methacrylate copolymer (Polyquaternium-107), 2-propene-1-aminium, N,N-dimethyl-N-2-propen-1-yl-, chloride (1:1), polymer with 2-hydroxy-1-methylethyl-2-propenoate and 2-propenoic acid (Polyquaternium-111), quaternized polysaccharides and polysaccharide derivatives, for example guar hydroxypropyltrimethylammonium chloride and hydroxypropylguar hydroxypropyltrimethylammonium chloride, chitosan hydroxypropyltrimethylammonium chloride, starch 3-(dodecyldimethylammonio)-2-hydroxypropyl 2-hydroxy-3-(trimethylammonio)propyl ether chloride (Polyquaternium-75) and hydroxypropyltrimethylammonium chloride starch.

The cationic polymer is preferably selected from poly(diallyldimethylammonium chloride) and quaternized hydroxyethyl cellulose. Most preferred is poly(diallyldimethylammonium chloride).

It is possible with preference to use water-soluble cationic polymers containing amino groups, more preferably polyethyleneimine, for the process according to the invention.

The aqueous binder is preferably added to the mixture as the last constituent.

The invention is described in detail hereinafter by working examples, but without being limited thereby.

### Methods

### Gel Permeation Chromatography (GPC)

The method described is not an absolute method. Instead, there is a need for calibration, which is conducted with commercially available poly-2-vinylpyridine standards that have a linear structure and are characterized by independent absolute methods. Instrument: Agilent 1100 from Agilent Technologies, pre-column: PSS NOVEMA Max, 10 μm, guard, ID 8.00 mm×50.00 mm, column: PSS NOVEMA Max Ultrahigh, 10 μm, ID 8.00 mm×300.00 mm, temperature 35° C., eluent: 0.1 M NaCl, 0.1 vol % TFA (aq.), flow rate 1 ml/min, sample concentration 3 g/l. RI detector, evaluation against a poly-2-vinylpyridine standard in the molar mass range of 620-2 890 000 g·mol⁻¹.

### Determination of Viscosity

Viscosities were measured in accordance with DIN 53019-1 using an MR301 rheometer from Anton Paar having cone/plate geometry, at a shear rate of 100 s⁻¹.

### Further Conditions

Where values are reported in % in the context of the present invention, these are % by weight values unless stated otherwise. In the case of compositions, percentages, unless defined differently, are based on the overall composition. Where averages are stated in the examples that follow, these are numerical averages unless stated otherwise. Where coatings are dried hereinafter, this is likewise accomplished at a pressure of 101 325 Pa, a temperature of 20° C. and ambient relative humidity of approx. 40% unless stated otherwise.

Materials and equipment
RM 10 W roller mixer, from CAT
Black PVC film (Leneta)
Coatmaster 509 MC film applicator, from Erichsen
ZAF 2010 box-type coating bar, from Zehntner
HPP110eco climate-controlled cabinet, from Memmert
Sigma Siloxan All Season ink, from PPG
Spray bottle with pump atomizer, from Technical Treatments
Dispermat with 30 mm disperser disc, from VMA Getzmann
TEGO Phobe® 1650, from Evonik
TEGO Phobe® 1409, from Evonik

### EXAMPLES

### 1. Production of the Aqueous Formulation According to the Invention

### 1.1 Cationic Polymer Solutions

Table 1 lists the commercially available aqueous cationic polymer solutions used with their weight-average molecular weights Mw (positions P1 to P4) determined by GPC. Quaternized hydroxyethyl cellulose is available in powder form, and so it was necessary to produce an aqueous polymer solution. For this purpose, the pulverulent 100% polymer was mixed manually with demineralized water in a 50 ml screwtop bottle using a spatula and placed on an RM 10 W roller mixer for 24 hours. The result was a homogeneous and clear solution that contained 20% by weight of the cationic polymer (position P5).

TABLE 1
Cationic polymer solutions used

| | | Conc. | | Mw |
|---|---|---|---|---|
| Pos. | Name | % by wt. | Source | g/mol |
| P1 | Poly(diallyldimethylammonium chloride) C40L/ | 40 | Trigon-Chemie | 73 700 |
| | Polyquaternium-6 | | | |
| P2 | Poly(diallyldimethylammonium chloride) C40H/ | 40 | Trigon-Chemie | 125 000 |
| | Polyquaternium-6 | | | |
| P3 | Poly(diallyldimethylammonium chloride) low | 35 | Sigma-Aldrich | 42 500 |
| | molecular weight/Polyquaternium-6 | | | |
| P4 | Poly(diallyldimethylammonium chloride) medium | 20 | Sigma-Aldrich | 200 000 |
| | molecular weight/Polyquaternium-6 | | | |
| P5 | Hydroxyethylcellulose ethoxylate, quaternized/ | 20 | Sigma-Aldrich | 398 000 |
| | Polyquaternium-10 | | | |

### 1.2 Hydrophobizing Agents Used

The following commercial hydrophobizing agents were used:
TEGO Phobe® 1650, from Evonik→(H1)
TEGO Phobe® 1409, from Evonik→(H2)

For the production of the aqueous formulation according to the invention, 100 g of H1 was weighed out in a 180 ml polyethylene cup. Subsequently, the cationic polymer solution from Table 1, in accordance with the concentration from Table 2, was added dropwise while stirring with a Dispermat at 500 rpm.

TABLE 2
Recipe of the inventive formulations comprising H1

| Formulation | Cationic polymer solution | Conc./% |
|---|---|---|
| Z 1-H1 | P1 | 2.0 |
| Z 2-H1 | P2 | 2.0 |
| Z 3-H1 | P3 | 2.0 |
| Z 4-H1 | P4 | 2.0 |
| Z 5-H1 | P5 | 2.0 |

### 2. Determination of Early Rain Resistance of a Facade Paint

### 2.1 Production of Facade Paints

Positions 1 and 2 from Table 3 were placed in a 180 ml polyethylene cup and homogenized for 5 minutes at 800 rpm with the aid of a Dispermat with a 30 mm disperser disc. Subsequently, positions 3 to 7 were added while stirring and incorporated for 10 minutes, in the course of which the speed was increased to 1500 rpm. Then positions 8 to 13 of the series were added and dispersed at 2500 rpm. After 30 minutes, the disperser disc was replaced by a paddle stirrer. The speed was reduced to 800 rpm, and positions 14 and 15 were added and incorporated. Lastly, the binder (position 16) and the thickener (position 17) were added while stirring. The mixture was stirred at 1000 rpm for another 10 minutes. After 24 hours, early rain resistance was determined.

TABLE 3
Recipe of the facade paint

| Pos. | Raw material | Manufacturer | Amount (g) |
|---|---|---|---|
| 1 | Demineralized water | — | 27.95 |
| 2 | WALOCEL ® XM 6000 PV | DOW | 0.3 |
| 3 | TEGO ® Foamex 24 | Evonik | 0.2 |
| 4 | ACTICIDE ® MBS | Thor | 0.15 |
| 5 | CALGON ® N new | Reininghaus Chemie | 0.05 |
| 6 | TEGO ® Dispers 715 W | Evonik | 0.3 |
| 7 | AMP-90 ™M | Angus | 0.1 |
| 8 | KRONOS ® 2310 | Kronos TITAN | 12.5 |
| 9 | SOCAL ® P3 | Imerys performance minerals | 10.0 |
| 10 | OMYACARB ® 5 GU | Omya | 15.0 |
| 11 | OMYACARB ® 2 GU | Omya | 10.0 |
| 12 | Mica TG | Aspanger Bergbau | 3.0 |
| 13 | SIPERNAT ® 820 A | Evonik | 2.0 |
| 14 | DOWANOL ® DPnB | DOW | 1.0 |
| 15 | Inventive aqueous formulation | Evonik | 4.8 |
| 16 | ACRONAL ® S790 | BASF | 12.0 |
| 17 | RHEOLATE ®278 TF | Elementis | 0.65 |
| | Total | | 100.0 |

### 2.2 Determination of Early Rain Resistance

With the aid of a box-type coating bar with a 200 μm slit and a Coatmaster 509 MC film applicator, films of the facade paints and of the comparative facade paints were drawn down onto black Leneta film at a rate of 15 mm/s. The coated films were then placed in a climate-controlled cabinet that had already been adjusted previously to 8° C. and 80% humidity. The films were dried in the cabinet for 20 minutes. Directly thereafter, the film was secured at an angle of 45° and sprayed with the aid of a spray bottle five times with 5.0 ml of demineralized water each time. Complete runoff of the water was awaited. The drawdowns were dried under standard laboratory conditions for 24 hours, and then assessed visually.

Comparative examples used were comparative facade paints VF1, VF2 and VF3.
VF1 was produced according to the recipe from Table 3, using neither a hydrophobizing agent nor a cationic polymer for position 15.
VF2 was produced according to the recipe from Table 3, using only 4.8% by weight of H1, but no cationic polymer, for position 15.
VF3 was produced according to the recipe from Table 3, additionally using 0.10 gram of the cationic polymer solution P4. P4 was added subsequently while stirring to the comparative facade paint according to the process regime from Example 1 of EP 1 250 388 B1.

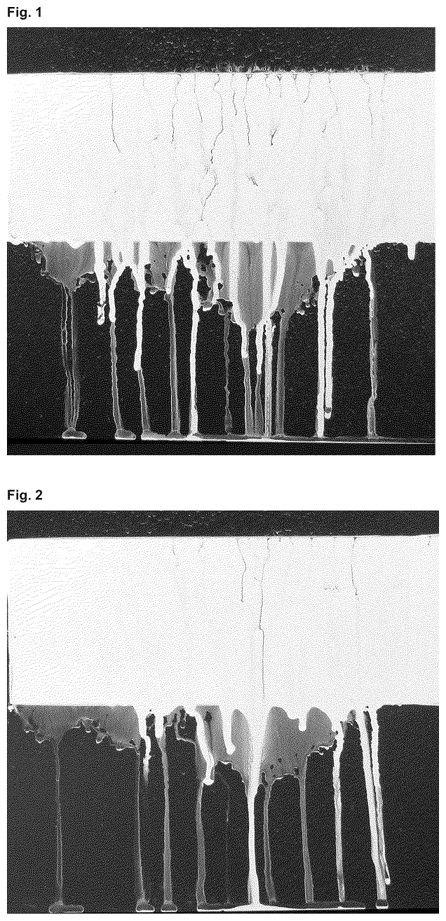

It was found that the surface of VF1 was inhomogeneous, with numerous cracks. Furthermore, the surface showed numerous thick, white runoff traces that reached down to the lower edge of the Leneta film (see FIG. 1). The early rain resistance of VF1 was assessed as being very poor.

It was found that the surface of VF2 was likewise inhomogeneous, with few cracks. Furthermore, the surface showed numerous thick, white runoff traces that reached down to the lower edge of the Leneta film (see FIG. 2). The early rain resistance of VF2 was assessed as being poor.

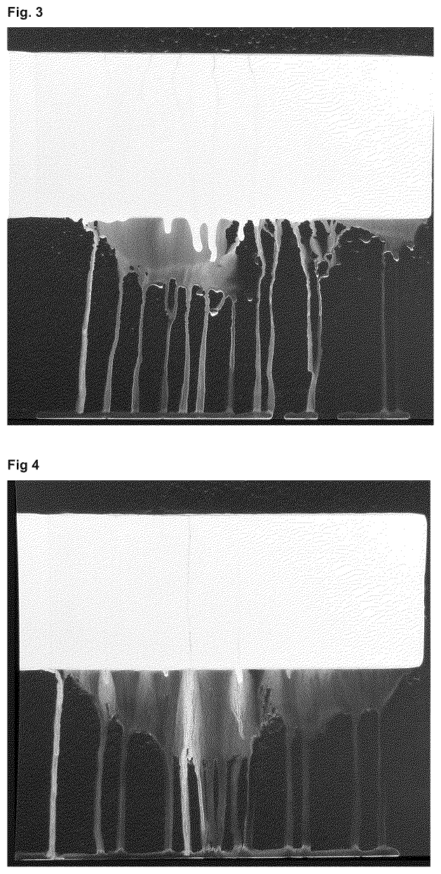

It was found that the surface of VF3 was smooth and homogeneous, with no cracks. Furthermore, the surface showed few thick, white runoff traces that did not reach down to the lower edge (see FIG. 3). The early rain resistance of VF3 was assessed as being moderate.

The early rain resistance of the facade paints according to the invention was compared with comparative facade paints VF1, VF2 and VF3. For better representation, the following settings were made: VF1=1 (very poor), VF2=2 (poor) und VF3=3 (moderate).

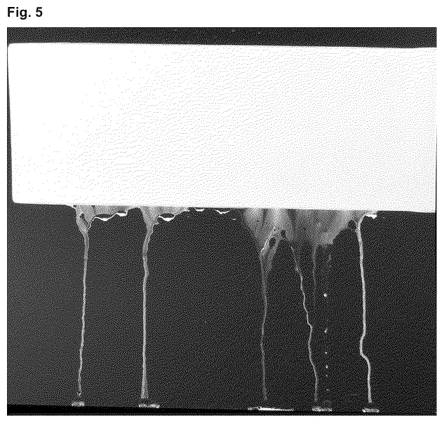

Table 4 shows the results of the early rain resistance of the facade paints according to the invention. It was found here that the surface of the inventive facade paints F1-F3 had a smooth, homogeneous surface without cracks, with individual thin white runoff traces that did not reach down to the lower edge. F4 and F5 showed a smooth, homogeneous surface without cracks, with individual thin runnel-like, slightly milky/turbid to translucent run-off traces that did not reach down to the lower edge. For this purpose, reference is made by way of example to FIG. 4 and FIG. 5.

TABLE 4
Visual assessment of early rain resistance

| Facade paint | Formulation | Rating |
|---|---|---|
| F1 | Z 1-H1 | 4 |
| F2 | Z 2-H1 | 4 |
| F3 | Z 3-H1 | 4 |
| F4 | Z 4-H1 | 5 |
| F5 | Z 5-H1 | 5 |

It was thus shown that the combination of hydrophobizing agents and water-soluble cationic polymers achieves an improvement in early rain resistance. The coatings produced with the aqueous formulations according to the invention had improved early rain resistance compared to a coating without hydrophobizing agents and without water-soluble cationic polymer, compared to a coating solely with hydrophobizing agents, and compared to a conventionally produced coating solely with a water-soluble cationic polymer.

### 2.3 Early Rain Resistance of Further Inventive Formulations

Analogously to 1.2, inventive formulations based on H2 with P4 were produced at two concentrations; see Table 5. Subsequently, analogously to 2.1, corresponding facade paints were produced according to Table 3. The results of the determination of early rain resistance can be found in Table 6.

TABLE 5
Recipe of the inventive formulations comprising H2 and P4

| Formulation | Cationic polymer solution | Conc. % |
|---|---|---|
| Z 4.1-H2 | P4 | 1.5 |
| Z 4.2-H2 | | 2.0 |

TABLE 6
Early rain resistance with further hydrophobizing agents

| | | Starting weight |
|---|---|---|
| Facade paint | Formulation | (g) = 4.8 |
| F6 | Z 4.1-H2 | 4 |
| F7 | Z 4.2-H2 | 4 |

It was shown here that the synergistic effect also occurred with another hydrophobizing agent.

### 2.4 Determination of Viscosity on Storage

In order to assess storage stability, the viscosity of the facade paints was measured. For this purpose, the inventive facade paint F4 and, as comparative examples, VF3 and VF4 were used to determine viscosity. VF4 was produced without H1, with subsequent addition of P4 according to Example 1 of EP 1 250 388 B1 to the comparative facade paint.

The facade paints were stored at 50° C. and the viscosity was measured at room temperature after 24 hours, after one week and after 2 weeks. The results are listed in Table 7.

TABLE 7
Viscosity on storage

| | Viscosity (mPa · s) | | |
|---|---|---|---|
| Facade paint | 24 h | 1 week | 2 weeks |
| F4 | 1134 | 1280 | 1291 |
| VF3 | 1174 | 1406 | 1346 |
| VF4 | 1256 | 1944 | 2317 |

It has been found that the viscosity of the facade paint according to the invention, produced with the formulation according to the invention, rises to a much lesser degree during storage than in the comparative examples. It is thus possible to make a positive statement as to the storage stability of the facade paint.

1. An aqueous formulation, comprising:
at least one aqueous hydrophobizing agent and at least one water-soluble cationic polymer.

2. The aqueous formulation according to claim 1, wherein the at least one water-soluble cationic polymer bears quaternary ammonium groups.

3. The aqueous formulation according to claim 1, wherein the at least one water-soluble cationic polymer bears amino groups.

4. The aqueous formulation according to claim 2, wherein the at least one water-soluble cationic polymer is at least one selected from the group consisting of poly(diallyldimethylammonium chloride), quaternized hydroxyethyl cellulose, and polyethyleneimine.

5. The aqueous formulation according to claim 1, wherein a the weight-average molecular weight of the water-soluble polymer is in a range of 10 000 g/mol to 2 000 000 g/mol.

6. The aqueous formulation according to claim 1, wherein the aqueous formulation includes 0.05% by weight-5.0% by weight of the water-soluble cationic polymer based on the formulation.

7. The aqueous formulation according to claim 1, wherein the at least one aqueous hydrophobizing agent is an aqueous silicone resin emulsion, a silicone oil emulsion, an emulsion or microemulsion of an amino-functional silicone oil, a silane emulsion, or mixtures thereof.

8. A method for producing an aqueous coating composition with early rain resistance, the method comprising:
mixing an aqueous formulation according to claim 1 as an additive with at least one aqueous binder thereby producing the aqueous coating composition with early rain resistance.

9. A coating composition, comprising:
an aqueous formulation according to claim 1.

10. The coating composition according to claim 9, wherein the coating composition is a render, a paint, a primer, or a wood paint for exterior applications.

11. A process for producing a coating composition having early water resistance, the process comprising:
a) producing an aqueous formulation consisting of at least one aqueous hydrophobizing agent and at least one aqueous cationic polymer solution, a weight-average molecular weight of which is in a the range of 10 000 g/mol to 1 000 000 g/mol
b) then adding at least one aqueous binder to the formulation obtained according to a) and
c) optionally, adding at least one selected from the group consisting of an emulsifier or a mixture of emulsifiers, film-forming aids, pigments, fillers, thickeners, levelling agents, protective colloids, dispersants, wetting agents, preservatives, and defoamers.

12. The process according to claim 11, wherein a proportion by weight of the at least one aqueous binder, based on a weight of dry material in the coating composition, is between 1.0-50.0% by weight.

13. The process according to claim 11, wherein the aqueous formulation includes 0.05% by weight-5.0% by weight of the at least one aqueous cationic polymer solution based on the formulation.

14. The process according to claim 11, wherein the at least one aqueous cationic polymer solution has quaternary ammonium groups or amino groups.

15. The process according to claim 14, wherein the cationic polymer is at least one selected from the group consisting of poly(diallyldimethylammonium chlorides), quaternized hydroxyethyl cellulose, and polyethyleneimine.

16. The process according to claim 11, wherein the at least one aqueous binder is an aqueous polymer dispersion based on homo- and/or copolymers.

17. The process according to claim 16, wherein the homo- and copolymers contain at least one olefinically unsaturated monomer as a monomer unit.

18. The process according to claim 11, wherein the at least one aqueous binder is added to the mixture as the last constituent if an emulsifier or a mixture of emulsifiers, film-forming aids, pigments, fillers, thickeners, levelling agents, protective colloids, dispersants, wetting agents, preservatives, and/or defoamers is used.

19. The aqueous formulation according to claim 1, wherein a weight-average of the water-soluble polymer is in a range of 30 000 g/mol to 500 000 g/mol.

20. The aqueous formulation according to claim 1, wherein the aqueous formulation includes 0.2%-2.0% by weight of the water-soluble cationic polymer based on the formulation.
